(19) United States
(12) Patent Application Publication
(10) Pub. No.: US 2013/0132135 A1
(43) Pub. Date: May 23, 2013

(54) Kennel System

(71) Applicant: Pets Too, LLC, Ellicott City, MD (US)

(72) Inventor: Andrew Galeone, Ellicott City, MD (US)

(73) Assignee: Pets Too, LLC, Ellicott City, MD (US)

(21) Appl. No.: 13/681,234

(22) Filed: Nov. 19, 2012

Related U.S. Application Data
(60) Provisional application No. 61/561,082, filed on Nov. 17, 2011.

(51) Int. Cl. A01K 1/00

(52) U.S. Cl. CPC A01K 1/0047
USPC 705/5; 119/449; 119/448

(57) ABSTRACT

A kennel system to be used commercially at hotels, resorts or during travel of the pet owner. The purpose of the kennel system is to allow pet owners to bring their pets with them to a hotel, hostel, resort or similar place of travel. The kennel system is largely automated and is monitored and controlled by the owner so that the hotel owner would be able to maintain the facility with a minimum of staff involvement. The owner would have total control of the care of the pet, using the automated features of the unit and controlled through a remote computer system. The kennel system includes indoor and outdoor exercise areas and secure physical access to the pet by the owner, who can take the pet out of the unit at any time for additional exercise and play time with the pet. The kennel system can be composed of singular or multiple kennels and includes automated food and water dispensers, and an automated waste cleaning system. The kennel system includes an online booking system for advance booking of a kennel linked to an advance booking system for the owner's lodging. Such online booking system would provide kennel occupancy information and booking options either through an independent online booking system or available through existing commercial sites.

### BACKGROUND

1. Field Of The Invention

This invention relates to a kennel system.

2. Background Of The Invention

Numerous kennels and systems exist to house pets while the owners are not present to care for the pets. The kennels are designed to protect the pet in the absence of the owner and also to prevent the pet from escaping and becoming lost. Pet hotels and pet sitting services provide care for pets while owner are away for extended periods of time. However, many pet owners would prefer not to leave their pets behind while they travel and would prefer to be able to take their pets with them. Due to potential damage or furnishings by pets and also in consideration of the safety and health of other guests, most public lodging establishments do not permit owners to bring pets with them unless a dog is a service animal. Therefore, there is a need to provide care for pets which travel with their owners and at the same time, protect the interests of the lodging establishment and of other guests.

### SUMMARY OF THE INVENTION

The present invention is drawn to a kennel system to be used commercially at hotels, resorts or during travel of the pet owner. The kennel system of the invention includes automatic feed and watering, indoor and outdoor exercise areas, remote monitoring of the pet by the owner, an automated waste cleaning system, and a security system which allows access only by the pet owner. Optionally included is an HVAC system for year-round temperature control, sound proofing and/or automatic disinfectant dispensing. The kennel system can be singular or multiple kennels.

Also included in the kennel system of the invention is an online booking system for advance booking of a kennel linked to an advance booking system for the owner's lodging.

### BRIEF DESCRIPTION OF THE FIGURES

FIG. 1 depicts a multiple kennel system housed in a building.

FIG. 2 shows the inside of the multiple kennel system of FIG. 1, illustrating the indoor and outdoor portions of the kennel system.

FIG. 2b is a flow chart that illustrates a waste removal system of the invention.

FIG. 3 shows a top view of a single kennel unit with an outdoor and an indoor exercise area of the kennel.

FIG. 4 shows a representative single outdoor kennel area.

FIG. 5 shows a side view of a single kennel unit with a cut-away view of an indoor and outdoor area of the kennel unit.

FIG. 6 shows a top perspective view of a single kennel unit.

FIGS. 7a-7f depict the remote communications capabilities of the kennel system and a GUI screen application for owner control and monitoring of the pet and the kennel unit.

FIGS. 8-8d depict the booking system of the invention.

### DETAILED DESCRIPTION OF THE INVENTION

The present invention is drawn to a kennel system to be used commercially at hotels, resorts or during travel of the pet owner. The purpose of the kennel system is to allow pet owners to bring their pets with them to a hotel, hostel, resort or the like, but the hotel owner would not have to deal with damage by the pet, allergies of pets by non-owner guests and religious sensitivities of other guests. The kennel system of the invention also relieves the lodging owner of care of the pet as well as the hotel owner would be able to maintain the facility with a minimum of staff involvement. The owner would have total control of the care of the pet, using the automated features of the unit. The kennel system includes indoor and outdoor exercise areas and secure physical access to the pet by the owner, who can take the pet out of the unit at any time for additional exercise and/or play time with the pet. The kennel system can be composed of singular or multiple kennels. The kennel system of the invention includes, but is not limited to automatic food and water dispensers, remote monitoring of the pet by the owner, an automated waste cleaning system, and a security system which allows access only by the pet owner. Alternatively, instead of automated dispensing, the owner is capable of controlling and/or modifying the dispensing of food and water either in person or remotely. Optionally included is an HVAC system for year-round temperature control, sound proofing and/or automatic disinfectant dispensing.

Also included in the kennel system of the invention is an online booking system for advance booking of a kennel linked to an advance booking system for the owner's lodging. Such online booking system would provide kennel occupancy information and booking options either through an independent online booking system or available through existing commercial sites including, but not limited to TRAVELOCITY, EXPEDIA, ORBITZ, and the like.

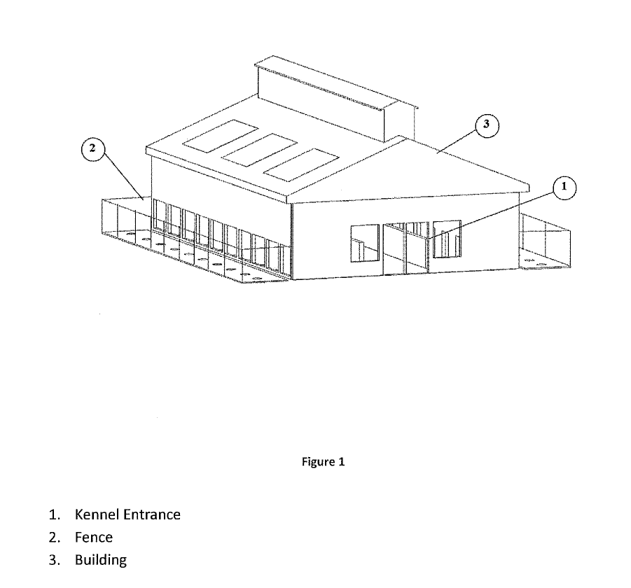

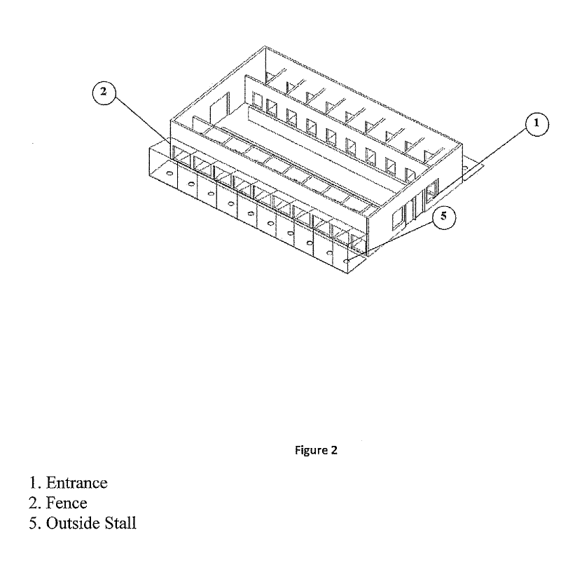

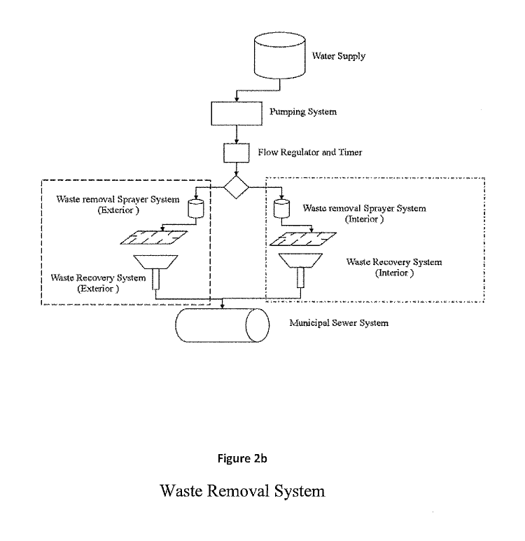

The kennel system of the invention is depicted in FIG. 1, wherein a plurality of individual kennel units are housed within one building 3 and accessible through a common kennel entrance 1 and the outdoor sections of the kennels are bounded by a fence 2. The kennels have an indoor section within a building 3, which optionally includes climate control for all-weather comfort and safety for the pets. FIG. 2 is a view of the kennel building with the roof removed and shows the outside fence 2, an inside kennel stall 4, outdoor kennel area 5, and includes an automated waste removal system. The size and number of kennel units are variable, from one unit to as many units as desired. The size and configuration of the kennel unit, as well as the respective sizes of the indoor and outdoor areas are variable. The kennel unit may also be entirely indoor, or outdoor, if desired. The building 3 may have solid walls to allow a climate control system and optional soundproofing, or the walls may be porous or manufactured from a fencing material for maximum outdoor air flow.

FIG. 2b is a flow chart that depicts a waste removal embodiment of the invention. A water supply is fed through a flow regulator with the use of a pumping system. The water system could be supplied through a municipal water supply system or provided locally through a well. The water then moves to both the interior and exterior areas of the kennel where the water is sprayed according to a schedule or the owner's control, to facilitate the removal of waste. The waste then moves with the water in a waste removal system to the municipal sewer system. The waste removal system can be covered with a grate or porous material for the protection of the pet and may be made of metal, plastic, wood or other suitable materials. The plumbing system connecting all the components of the waste removal system would be installed according to local plumbing and health codes.

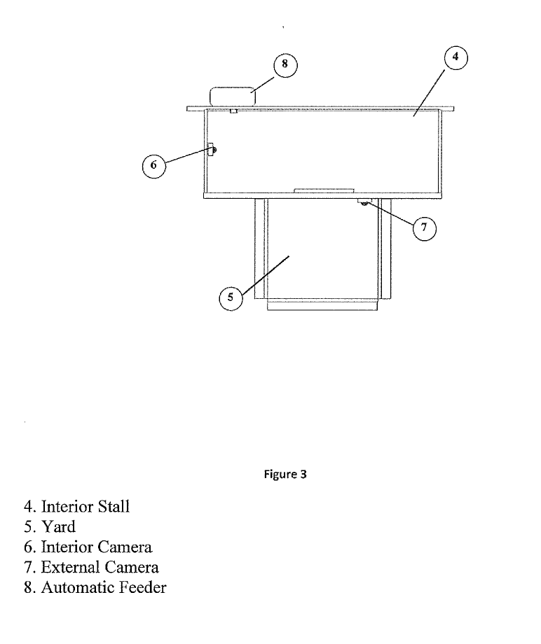

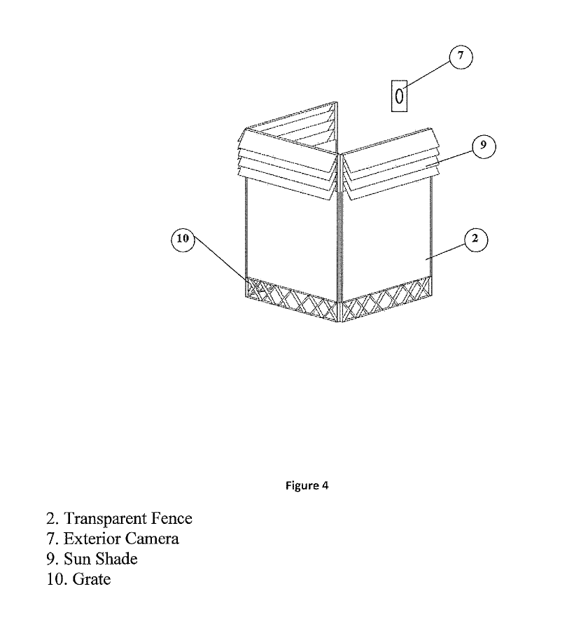

FIG. 3 illustrates an individual kennel unit. The indoor 4 and outdoor 5 areas are shown, along with an interior camera 6 and an outdoor camera 7. The number and positions of the cameras are variable depending on the desires of the kennel owner and manufacturing requirements. An optional feeder 8 is also included. The feeder may be automatic, or controlled by the owner, either remotely or manually. FIG. 4 shows additional features of an individual unit, such as a sun shade 9 and a grate 10, which allows additional air flow, particularly if the fence 2 is a solid transparent screen.

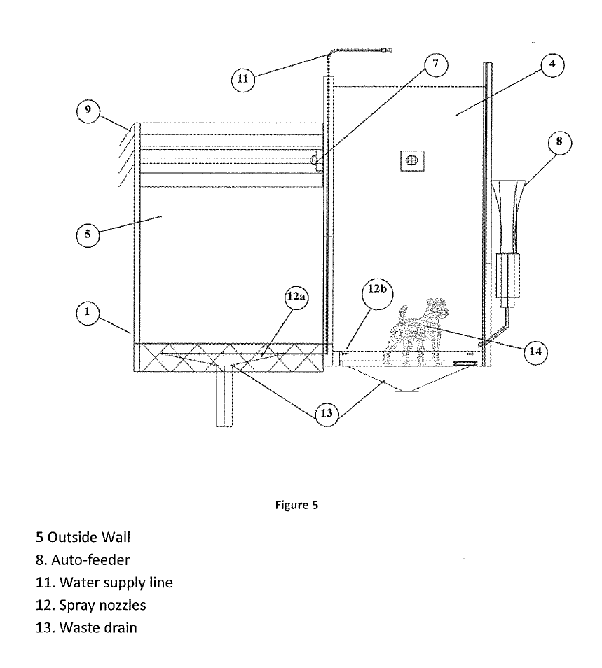

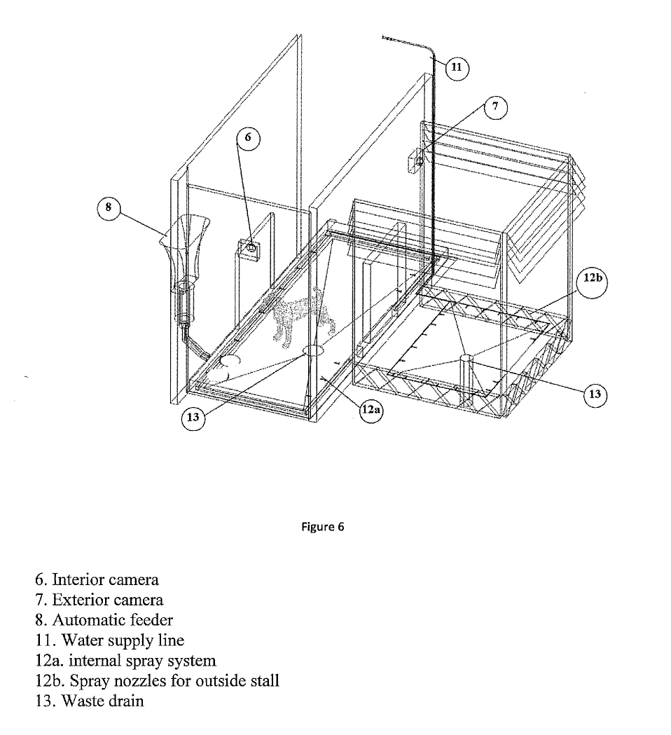

FIGS. 5 and 6 show a kennel unit in use by a pet 14. An embodiment of the waste disposal system of the invention is shown, wherein a water supply line 11 is provided to the kennel unit, and leads to spray nozzles 12a and 12b, located in both the indoor 4 and outdoor 5 kennel areas. While one animal is illustrated 14, it is understood that an owner may house more than one pet, particularly if pets live together in the owner's home.

The location of the nozzles 12a and 12b and the water supply line 11 are optimized during manufacture and construction and it is understood that the locations of the nozzles and the water supply line will be optimally-placed. Water would be supplied from municipal or other potable water sources and can also be used to supply water for an automatic drinking water supply which may be part of the automatic feeder 8, or freestanding. In one embodiment, the activation of the water nozzles 12a and 12b for cleaning would only occur in the absence of the animal 14, as detected by motion sensors or by camera sensors 6, 7. In another embodiment, the activation of the water would be timed. The waste water then moves into a waste drain 13, which in turn feeds into a public waste disposal system. An alternative embodiment includes a conveyor system or trough to move the waste to the public sewer system. Feline waste can be handled through automated litter containers which can self-clean and refill with fresh litter. Appropriate plumbing traps and vents are included as required by local code requirements. Optional deodorizers and fans are included to reduce offensive odors from concentrating in the kennels.

It is understood that the invention includes kennels that can house common pets such as dogs and cats, but also built to accommodate larger animals such as horses or other livestock. For housing a cat, the kennel would include jumping areas or scratching post, for example. The facility could also be used by veterinarians for housing of their patients, by law enforcement for housing K-9 or other working dogs, or for other “pet motel” uses.

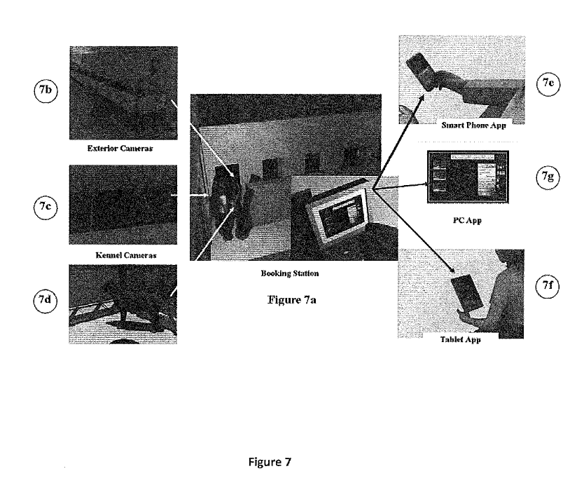

FIG. 7 illustrates the remote control aspects of the invention. FIG. 7a demonstrates an embodiment of a booking station used to check in a pet by the owner. The computer system (inset) allows the owner to customize the stay for their pet, such as feeding times, and the like and to enter contact information, room number, schedule, and the like. The computer system allows for monitoring of the pet through the camera systems installed in the kennels as shown in FIGS. 7b through 7d. The kennel can be monitored and customized through a workstation (FIG. 7a inset), a smart phone (FIG. 7e), a tablet device (FIG. 7f), or a combination thereof. A GUI interface (FIG. 7g) allows ease of use for the owner. A security encryption or password system allows access only to the owner(s). The computer system can also be used to allow the owner physical access to the dog, by unlocking doors to the kennel.

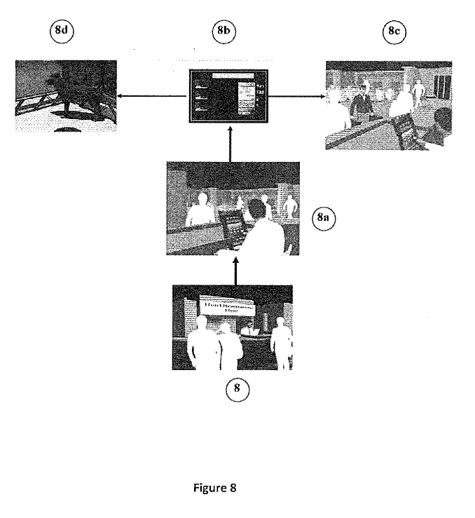

A kennel booking system of the invention is shown in FIG. 8. A pet owner may establish the presence of a kennel system at their place of lodging or resort either through the hotel or resort reservation service or through third party companies, such as ORBITZ, TRAVELOCITY, EXPEDIA or the like. Availability, prices, accommodations, special needs and requests, and length of stay can be booked similar to the procedure for booking a hotel room. The customer books both the hotel room and the kennel at the same time.

FIG. 8 shows a traveller approaching a hotel reservation to book the pet into a kennel unit. FIG. 8a shows the traveller working with a kennel-associated GUI screen, as shown in 8b, for booking of the pet. FIGS. 8c and 8d show the control of the kennel via the GUI screen (FIG. 8c) and the dog ultimately in the kennel (FIG. 8d).

The invention also includes tracking the movement of an individual pet through the use of unique RFID chips or tags, or similar tracking devices as an additional means to secure and monitor the pet.

Having now fully described this invention, it will be understood to those of ordinary skill in the art that the same can be performed within a wide and equivalent range of conditions, formulations, and other parameters without affecting the scope of the invention or any embodiment thereof. All patents and publications cited herein are incorporated by reference in their entirety.

I claim:

1. A pet kennel system comprising:
an indoor pet housing area,
an automated food and watering system,
an indoor exercise area,
remote monitoring system, and
security system, and
wherein said pet kennel system is commercially available at vacation locations and wherein a customer reserves a pet kennel unit via an advance booking system.

2. The advance booking system of claim 1 which is an online booking system.

3. The online booking system of claim 2, wherein the kennel unit booking is linked to an overnight lodging room.

4. The online booking system of claim 3 wherein the online booking system is accessed from a group consisting of: a hotelier-owned online reservation system, a kennel reservation system, a convention or visitor's bureau, a travel agency, an online booking entity, and a reservation aggregator.

5. The pet kennel system of claim 1 which also comprises an HVAC system.

6. The pet kennel system of claim 1 also comprising an outdoor exercise area.

7. The pet kennel system of claim 1 also comprising an automated waste disposal system.

8. The pet kennel system of claim 1 wherein the owner can regulate the amount of water and food dispensed by a remote means.
